(19) United States
(12) Patent Application Publication
(10) Pub. No.: US 2012/0114433 A1
(43) Pub. Date: May 10, 2012

(54) Wheel mandrel for toy cars

(76) Inventor: Thomas Alan Davis, Sunnyvale, CA (US)

(21) Appl. No.: 12/927,156

(22) Filed: Nov. 8, 2010

(51) Int. Cl. B26D 1/12

(52) U.S. Cl. 407/30

(57) ABSTRACT

A wheel mandrel tool includes an alignment section, a thread forming section including a first set of grooves, a gripping section including a second set of grooves, and a shank section. The thread forming section forms threads in a wheel bore by a swaging process and the gripping section holds the wheel during a rotary trimming process.

### BACKGROUND OF THE INVENTION

1. Field of the Invention

The present invention relates generally to tools used in performance tuning of toy car wheels, and more particularly to tools that provide swage threading of a wheel bore, and to tools that enable the removal of wheel tread imperfections.

2. Background of the Invention

Toy cars are used in a wide variety of games and activities. In some toy car competitions, the toy cars are raced down a sloped track, using only gravity to provide their kinetic energy. Examples of toy cars include Boy Scouts of America Pinewood Derby and PineCar Racer toy cars. The present invention is not limited to use on these cars, but can be applied generally to toy cars. To enhance the performance of toy cars, it is common practice to remove imperfections from the treads of the wheels using a process known as rotary trimming. In the rotary trimming process, the toy car wheel is held using an apparatus known as a mandrel, placing the mandrel into a drill or similar tool, and pressing a blade or similar flat object against the tread surface of the spinning wheel to remove any high-spots or other imperfections.

Prior art wheel mandrel tools are of two piece construction: a threaded screw and threaded mandrel base. The threaded screw is inserted through the wheel bore (i.e. the opening in the wheel through which the axle is placed) and then screwed into the threaded mandrel base. The screw holds the wheel on the mandrel in a concentric arrangement. The mandrel base is placed into the chuck of a drill or similar tool, and the chuck is tightened to hold the mandrel. To remove imperfections from the wheel tread, the drill is turned on to spin the wheel, and a blade, sandpaper, or other tools are pressed against the spinning wheel. Buffing of the wheel tread is also possible using this process by application of buffing compound to the spinning wheel.

Prior art wheel mandrels have several shortcomings. First, prior art wheel mandrels function only to hold a wheel, allowing the wheel to be attached to, and spun by, a drill, in order to remove tread imperfections as described above. Prior art wheel mandrels do not change the inside surface of the wheel bore. Furthermore, because the threaded screw portions of these tools have a smaller diameter than the wheel bore, they may not fit tightly enough to ensure that the wheel tread is concentric to the drill axis. Thus, the wheel tread and the wheel bore may not be concentric after trimming the wheel tread. To minimize this issue, some prior-art wheel mandrels provide a conical centering portion on the head of the threaded screw. This conical section centers the wheel on the tool ensuring concentricity of wheel bore to the circumference of the wheel.

The present invention provides a wheel mandrel that overcomes the weaknesses of prior-art tools, providing a dual function mandrel having particular utility for swage threading and holding a work piece for rotary trimming.

### SUMMARY

In one embodiment, a wheel mandrel tool comprises a work piece alignment section, a thread forming section including a first set of grooves, the first set of grooves having a first inner diameter and a first outer diameter, a work piece gripping section including a second set of grooves, the second set of grooves having a second inner diameter and second outer diameter, and a shank section. The present invention advantageously provides dual functions of swage threading the wheel bore and holding the wheel during rotary trimming. The wheel mandrel is preferably made of one piece construction,

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic cross-section a prior-art toy car wheel that may be improved by application of the present invention.

FIG. 2 shows a cross-section schematically illustrating of one embodiment of the present invention.

FIG. 3 shows an enlarged cross-section of one portion of the embodiment of the present invention shown in FIG. 2.

The use of the same reference label in different drawings indicates the same or like components. The drawings are not necessarily drawn to scale.

### DETAILED DESCRIPTION

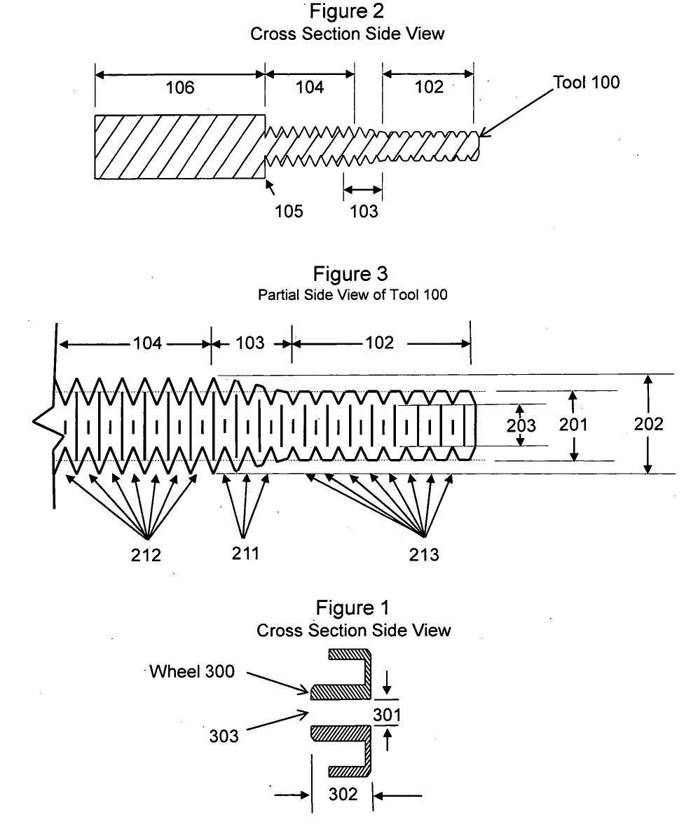

FIG. 1 shows a schematic cross-section of a prior-art toy car wheel 300. Wheel 300 includes a wheel bore 303 (i.e. the hole through which a toy car axle is placed). The wheel bore has an initial wheel bore diameter 301 and a wheel bore length 302.

FIG. 2 shows a schematic cross-section of one embodiment of the present invention. Wheel mandrel 100 includes an alignment section 102, a thread forming section 103, a gripping section 104, and a shank section 106. Unlike some prior-art wheel mandrels, the present invention is preferably made of one piece construction. In other words, sections 102, 103, 104, and 106 are not easily separated from each other, and are all preferably formed from the same piece of material.

Shank section 106 has a diameter that is substantially constant throughout its length. The length of shank section 106 should be sufficient to be held in the spinning tool chuck, and should protrude well beyond the chuck to prevent injury during the wheel trimming process.

To use wheel mandrel 100 for enhancing the performance of toy car wheel 300, shank section 106 is placed into the chuck of a spinning tool (e.g. a drill). Prior to threading wheel 300 onto tool 100, a lubricant may optionally be placed on tool 100 to minimize the risk of thread tear out prior to thread formation. While tool 100 is spinning, the wheel 300 is placed on alignment section 102, which centers wheel 300 onto tool 100. Wheel 300 is pressed against thread forming section 103 such that thread forming section 103 begins to cut threads into wheel bore 303. This threading process also pulls wheel 300 further onto tool 100. As wheel 300 travels across thread forming section 103 to gripping section 104, the entire length of wheel bore 303 becomes threaded by a thread swaging process. A shoulder stop 105 prevents the wheel from traveling onto shank section 106. Shoulder stop 105 is preferably substantially perpendicular to the tool axis, and preferably has a smooth finish. In another embodiment, shoulder stop 105 may be chamfered.

Gripping section 104 serves to hold wheel 300 securely and concentrically on wheel mandrel 100 during the subsequent wheel tread trimming process. The length of gripping section 104 is preferably as long as, or longer than, the wheel bore length 302, such that the gripping area between the wheel and gripping section 104 is maximized. The shank section 106 remains in the chuck of the drill and the drill spins the wheel while a blade, sandpaper, or other tool is pressed against the spinning wheel to remove imperfections from the tread of the wheel. Buffing of the wheel tread is also possible by application of buffing compound to the spinning wheel. After the wheel tread trimming process is completed, wheel 300 may be prevented from spinning while the spinning direction of the drill is reversed, such that wheel 300 is unscrewed from tool 100 for easy removal.

FIG. 3 shows a schematic cross-section of an enlarged area of the tool of FIG. 2 to illustrate additional features of the present invention. Thread forming section 103 includes a first set of grooves 211, which have a first inner diameter 203. The outer diameter of grooves 211 varies with lateral position, with a minimum outer diameter 201 near alignment section 102 and a maximum outer diameter 202 near gripping section 104. The length of thread forming section 103 will influence the gripping force required to thread the wheel bore. Increasing the length decreases the gripping force required on the wheel during thread formation. In a preferred embodiment, the length of thread forming section 103 is in the range of ⅛ inch to ¼ inch. Thread forming section 103 can be configured for lobed swage thread forming, or to swage threads without lobes.

Outer diameter 202 is a critical dimension for thread swaging. Outer diameter 202 should be greater than initial wheel bore diameter 301. If outer diameter 202 is too small, then threads are not completely formed inside wheel bore 303. However, if outer diameter 202 is too large, then the threads may be damaged during the thread formation process. The correct diameter should allow displaced wheel material (e.g. plastic) to substantially fill grooves 212. Swaged threads are preferred to cut threads because the swaging process reduces wheel bore diameter from initial wheel bore diameter 301 to a final wheel bore diameter. The final wheel bore diameter is preferably just slightly larger than the diameter of a wheel axle that is used to hold the wheel onto the toy car.

Alignment section 102 has a diameter that preferably similar to the wheel bore diameter 301 (see FIG. 1). Making the diameter of alignment section 102 the same or only slightly smaller than the wheel bore diameter ensures that the wheel is positioned concentrically on the tool before the wheel contacts grooves 211 in thread forming section 103. The length of alignment section 102 is preferably similar to wheel bore length 302 (see FIG. 1) in wheel 300. Alignment section 102 may have a chamfered edge, as shown in FIG. 2. In the embodiment of FIG. 3, alignment section 102 has a set of grooves 213. Grooves in the alignment section may prevent damage to the threaded wheel bore when the wheel is removed from the wheel mandrel upon completion of the operation. The inner diameter 203 of grooves 213 is preferably the same as the inner diameter 203 of grooves 211.

Gripping section 104 has a set of grooves 212 with an inside diameter 203 that is preferably the same as inside diameter 211, and an outside diameter 202 that is substantially the same as the largest outside diameter of grooves 211. Grooves 212 should fit tightly into the threads that are cut into wheel bore 303 by threading section 103 of tool 100.

In a preferred embodiment, grooves 212, grooves 211, and grooves 213 are continuous across gripping section 104, threading section 103, and alignment section 102. The inner diameter 203 is consistent across grooves 212, 211, and 213. The outer diameter 202 of gripping section 104 is larger than the outer diameter 201 of alignment section 102, and the outer diameter of grooves 211 vary from outer diameter 202 to outer diameter 201. In another embodiment, alignment section 102 may have a smooth surface (i.e. a uniform diameter with no grooves). In a preferred embodiment, grooves 211, 212, and 213 are formed as a standard machine screw thread.

An improved wheel mandrel has been disclosed. While specific embodiments of the present invention have been provided, it is to be understood that these embodiments are for illustration purposes and not limiting. Many additional embodiments will be apparent to persons of ordinary skill in the art reading this disclosure.

1. A wheel mandrel tool comprising:
an alignment section;
a thread forming section adjacent the alignment section, the thread forming section including a first set of grooves, the first set of grooves having a first inner diameter and a first outer diameter;
a gripping section adjacent the thread forming section, the gripping section including a second set of grooves, the second set of grooves having a second inner diameter and second outer diameter; and
a shank section adjacent the gripping section.

2. The wheel mandrel tool of claim 1 wherein:
the first inner diameter is substantially the same as the second inner diameter; and
the alignment section has a third diameter that is substantially uniform and less than or equal to the first inner diameter.

3. The wheel mandrel tool of claim 1 wherein:
the first inner diameter is substantially the same as the second inner diameter;
the alignment section has a third set of grooves having a third inner diameter and a third outer diameter;
the third inner diameter is the substantially the same as the first inner diameter; and
the third outer diameter is less than an initial wheel bore diameter.

4. The wheel mandrel tool of claim 1 wherein the second outer diameter is greater than an initial wheel bore diameter.

5. The wheel mandrel tool of claim 3 wherein the first outer diameter varies monotonically from the second outer diameter to the third outer diameter.

6. The wheel mandrel tool of claim 2 wherein the first outer diameter varies monotonically from the second outer diameter to the third diameter.

7. The wheel mandrel tool of claim 1 wherein the alignment section, thread forming section, gripping section, and shank section are of one piece construction.

8. The wheel mandrel tool of claim 1 wherein the thread forming section is configured to concentrically center a wheel on the wheel mandrel tool.

9. The wheel mandrel tool of claim 1 wherein:
the shank section has a fourth diameter that is substantially uniform and is substantially greater than the second outer diameter;

10. The wheel mandrel tool of claim 1 wherein the alignment section, the thread forming section, the gripping section, and the shank section are each concentric about a first axis and are arranged linearly along the first axis.

11. The wheel mandrel tool of claim 10 further comprising a shoulder stop disposed between the gripping section and the shank section, the shoulder stop having a surface that is substantially perpendicular to the first axis.

12. The wheel mandrel tool of claim 1 wherein the gripping section has a second length exceeding a wheel bore length.

13. A wheel mandrel tool comprising:
a thread forming section including a first set of grooves, the first set of grooves having a first inner diameter and a first outer diameter;
a gripping section including a second set of grooves, the second set of grooves having a second inner diameter and a second outer diameter;
an alignment section including a third set of grooves having a third inner diameter and a third outer diameter; and
a shank section having a fourth diameter; wherein
the first inner diameter, the second inner diameter, and the third inner diameter are all substantially the same;
the second outer diameter is greater than an initial wheel bore diameter;
the third outer diameter is less than an initial wheel bore diameter;
the first outer diameter varies monotonically from the second outer diameter to the third outer diameter; and
the fourth diameter is substantially uniform and substantially greater than the second outer diameter.

14. The wheel mandrel tool of claim 13 wherein the alignment section, the thread forming section, the gripping section, and the shank section are of one piece construction.

15. The wheel mandrel tool of claim 13 wherein the alignment section, the thread forming section, the gripping section, and the shank section are each concentric about a first axis and are arranged linearly along the first axis.

16. The wheel mandrel tool of claim 15 further comprising a shoulder stop disposed between the gripping section and the shank section, the shoulder stop having a surface that is substantially perpendicular to the first axis.

17. The wheel mandrel tool of claim 13 wherein the gripping section has a second length exceeding a wheel bore length.
